(19) United States
(12) Patent Application Publication
(10) Pub. No.: US 2025/0383444 A1
(43) Pub. Date: Dec. 18, 2025

(54) DISTANCE SENSING METHOD AND APPARATUS

(71) Applicant: GUANGZHOU LUXVISIONS INNOVATION TECHNOLOGY LIMITED, Guangzhou City (CN)

(72) Inventor: Hsiu-Chih Lin, Guangzhou City (CN)

(73) Assignee: GUANGZHOU LUXVISIONS INNOVATION TECHNOLOGY LIMITED, Guangzhou City (CN)

(21) Appl. No.: 19/025,352

(22) Filed: Jan. 16, 2025

(30) Foreign Application Priority Data
Jun. 17, 2024 (CN) 202410784711.6

(51) Int. Cl. G01S 17/08; G01S 7/48; G01S 7/481

(52) U.S. Cl. CPC G01S 17/08; G01S 7/4808; G01S 7/4814

(57) ABSTRACT

A distance sensing method and apparatus are provided. The distance sensing apparatus includes: a transmit module and a receive module. An operand element of the receive module is configured to send a driving signal to a driving element of the transmit module to drive a light-emitting element to output a light ray having a predetermined wavelength range. After passing through a diffractive optical element of the transmit module, the light ray images a first diffraction pattern at a first distance and a second diffraction pattern at a second distance, respectively. A sensing element of the receive module is configured to sense and convert the light ray into light wave information. The operand element is configured to obtain a measured distance in accordance with the light wave information, a first algorithm corresponding to the first diffraction pattern, and a second algorithm corresponding to the second diffraction pattern.

### CROSS-REFERENCE TO RELATED APPLICATION

This non-provisional application claims priority under 35 U.S.C. § 119(a) to patent application Ser. No. 202410784711.6 filed in China on Jun. 17, 2024, the entire contents of which are hereby incorporated by reference.

### BACKGROUND

### Technical Field

The present disclosure relates to a distance sensing apparatus, and in particular, to an optical distance sensing apparatus.

### Related Art

In recent years, mobile phones, augmented reality (AR) apparatuses, virtual reality (VR) apparatuses, robots, and in-vehicle apparatuses need to be equipped with depth sensing elements. It is known that a depth sensing element measures a depth by using a light source, a diffractive optical element (DOE), and a sensor. For example, the light source forms a light spot pattern at a predetermined distance when passing through the diffractive optical element, and the sensor senses the light spot pattern to calculate a distance to obtain the depth.

### SUMMARY

In view of this, some embodiments of the present disclosure provide a distance sensing apparatus including a transmit module and a receive module. The transmit module includes a diffractive optical element, a light-emitting element, and a driving element. The diffractive optical element includes a first sub-pattern and a second sub-pattern. The light-emitting element is configured to be driven to output a light ray toward the diffractive optical element, where the light ray has a predetermined wavelength range, and when passing through the diffractive optical element, the light ray forms a first diffraction pattern at a first distance and a second diffraction pattern at a second distance, respectively. The driving element is configured to receive a driving signal and drive the light-emitting element. The receive module includes a sensing element, a memory element, and an operand element. The sensing element is configured to sense and convert the light ray having the predetermined wavelength range into light wave information. The memory element is configured to store the light wave information. The operand element is configured to send the driving signal and obtain a measured distance in accordance with the light wave information, a first algorithm, and a second algorithm, where the first algorithm corresponds to the first diffraction pattern, and the second algorithm corresponds to the second diffraction pattern.

In some embodiments, the operand element is configured to obtain a second algorithm value in accordance with the light wave information and the second algorithm; and the operand element is configured to take the second algorithm value as the measured distance when the second algorithm value meets a second range.

In some embodiments, the operand element is configured to obtain a first algorithm value in accordance with the light wave information and the first algorithm when the second algorithm value does not meet the second range; and the operand element is configured to take the first algorithm value as the measured distance when the first algorithm value meets a first range.

In some embodiments, the operand element is configured to obtain the measured distance in accordance with the first algorithm value, the second algorithm value, and a third algorithm when the first algorithm value does not meet the first range.

The present disclosure further provides a distance sensing method including: sending a driving signal to generate a light ray to cause the light ray to image a first diffraction pattern at a first distance and image a second diffraction pattern at a second distance; sensing and converting the light ray having a predetermined wavelength range into light wave information; and obtaining a measured distance in accordance with the light wave information, a first algorithm, and a second algorithm, where the first algorithm corresponds to the first diffraction pattern, and the second algorithm corresponds to the second diffraction pattern.

In summary, according to the distance sensing apparatus and method provided in some embodiments, a first algorithm value corresponding to a first distance is obtained in accordance with light wave information and a first algorithm, and a second algorithm value corresponding to a second distance is obtained in accordance with the light wave information and a second algorithm. In this way, in the distance sensing apparatus and method, the first algorithm value corresponding to the first distance or the second algorithm value corresponding to the second distance may be taken as a measured distance, or a third algorithm value obtained in accordance with the first algorithm value, the second algorithm value, and a third algorithm may be taken as the measured distance, so that the measured distance can be obtained more accurately. In some embodiments, in accordance with the distance sensing apparatus and method, the measured distance can be obtained more accurately through imaging of corresponding diffraction patterns at a plurality of distances respectively and calculation using algorithms corresponding to the diffraction patterns.

### BRIEF DESCRIPTION OF THE DRAWINGS

FIG. 1 is a schematic structural diagram of a distance sensing apparatus according to some embodiments;

FIG. 2 is a schematic diagram of patterns imaged by a distance sensing apparatus at different distances according to some embodiments;

FIG. 3 is a schematic planar diagram of a partial structure of a diffractive optical element according to some embodiments;

FIG. 4 is a schematic cross-sectional view of FIG. 3 at a position 4-4′, showing a first thickness of a first pixel and a second thickness of a second pixel;

FIG. 5 is a three-dimensional exploded view of a diffractive optical element according to some embodiments;

FIG. 6 is a flowchart of a distance sensing method according to some embodiments;

FIG. 7 is a flowchart of step S84 of a distance sensing method according to some embodiments;

FIG. 8-1, FIG. 8-2, and FIG. 8-3 are schematic diagrams of a first microstructure pattern, a second microstructure pattern, a first sub-pattern, a second sub-pattern, and a spliced pattern according to some embodiments;

FIG. 9 is a schematic diagram of a spliced pattern according to some embodiments; and

FIG. 10 is a partially enlarged schematic view of a spliced pattern according to some embodiments, where the spliced pattern is formed by splicing a first sub-pattern, a second sub-pattern, and a third sub-pattern.

### DETAILED DESCRIPTION

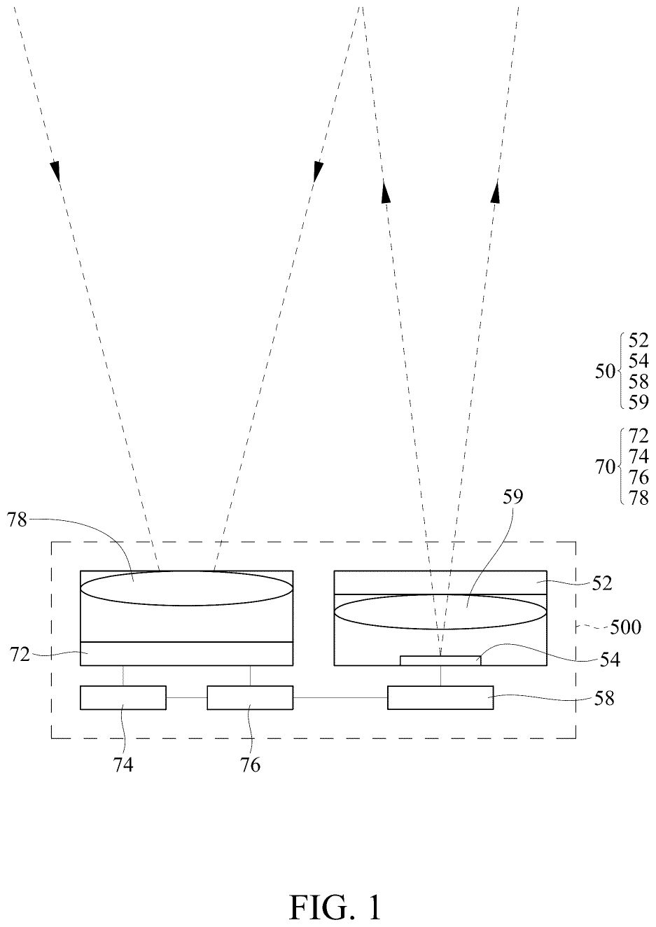

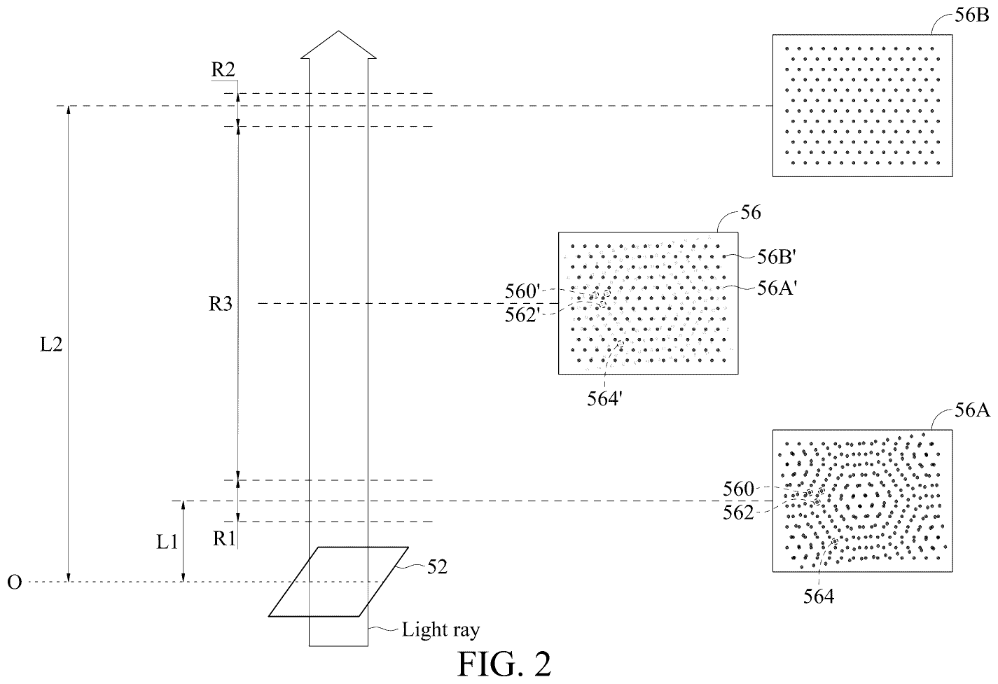

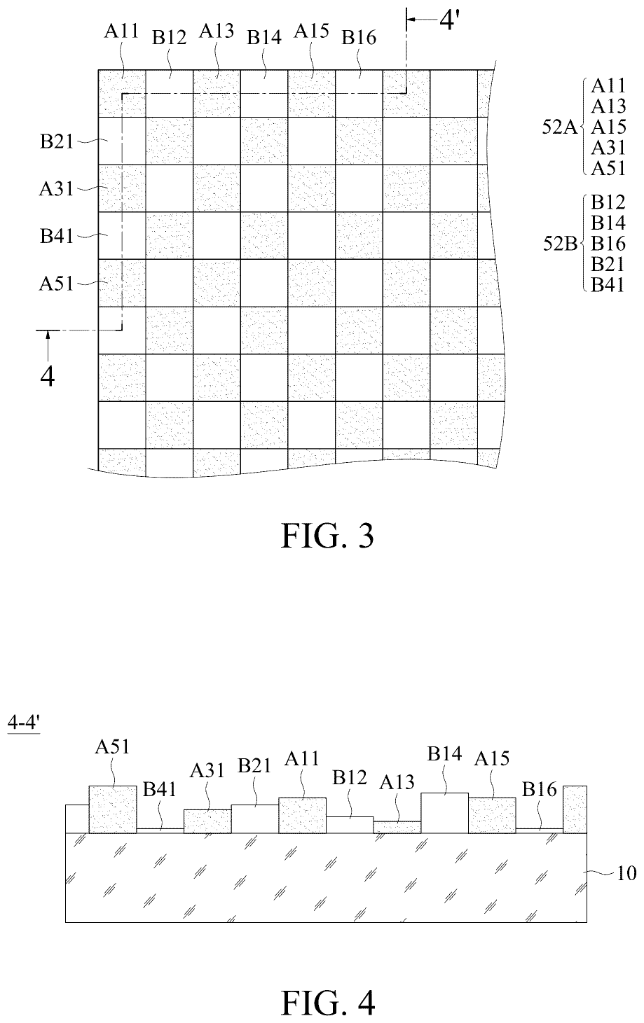

Refer to FIG. 1, FIG. 2, and FIG. 3. FIG. 1 is a schematic structural diagram of a distance sensing apparatus according to some embodiments; FIG. 2 is a schematic diagram of patterns imaged by a distance sensing apparatus at different distances according to some embodiments; and FIG. 3 is a schematic planar diagram of a partial structure of a diffractive optical element according to some embodiments. According to some embodiments, a distance sensing apparatus 500 includes a transmit module 50 and a receive module 70. The transmit module 50 includes a diffractive optical element 52, a light-emitting element 54, and a driving element 58. The diffractive optical element 52 includes a first sub-pattern 52A and a second sub-pattern 52B (as shown in FIG. 3). The light-emitting element 54 is configured to be driven to output a light ray toward the diffractive optical element 52, where the light ray has a predetermined wavelength range. When passing through the diffractive optical element 52, the light ray forms a first diffraction pattern 56A at a first distance L1 and a second diffraction pattern 56B at a second distance L2, respectively (as shown in FIG. 2). The driving element 58 is configured to receive a driving signal and drive the light-emitting element 54. The receive module 70 includes a sensing element 72, a memory element 74, and an operand element 76. The sensing element 72 is configured to sense and convert the light ray having the predetermined wavelength range into light wave information. The memory element 74 is configured to store the light wave information. The operand element 76 is configured to send the driving signal and obtain a measured distance in accordance with the light wave information, a first algorithm, and a second algorithm, where the first algorithm corresponds to the first diffraction pattern 56A, and the second algorithm corresponds to the second diffraction pattern 56B.

Therefore, after the light-emitting element 54 is driven to emit a light ray, the light ray exits through the diffractive optical element 52 and is reflected by a to-be-measured object (not shown in the drawing). Then, the sensing element 72 of the receive module 70 receives the reflected light ray. When the light wave information received by the sensing element 72 is the first diffraction pattern 56A, it indicates that a distance between the to-be-measured object and the distance sensing apparatus 500 is the first distance L1. When the light wave information received by the sensing element 72 is the second diffraction pattern 56B, it indicates that the distance between the to-be-measured object and the distance sensing apparatus 500 is the second distance L2. In addition, when the light wave information received by the sensing element 72 is close to the first diffraction pattern 56A or close to the second diffraction pattern 56B, it indicates that the distance between the to-be-measured object and the distance sensing apparatus 500 is close to the first distance L1 or the second distance L2. A degree to which the distance is close to the first distance L1 or the second distance L2 is described later.

The second distance L2 is greater than the first distance L1. In some embodiments, the first distance L1 is 60 cm, and the second distance L2 is 100 cm. The first diffraction pattern 56A is a random light spot, and the second diffraction pattern 56B is a regular light spot. The light-emitting element 54 is a vertical cavity surface emitting laser (VCSEL). The predetermined wavelength range may be an infrared (IR) wavelength range, for example, but not limited to, 760 nm (nanometers) to 1000 nm. The driving element may be a laser driving chip. The memory element 74 may be an electrically-erasable programmable read-only memory (EEPROM). The sensing element 72 may be a single photon avalanche diode (SPAD).

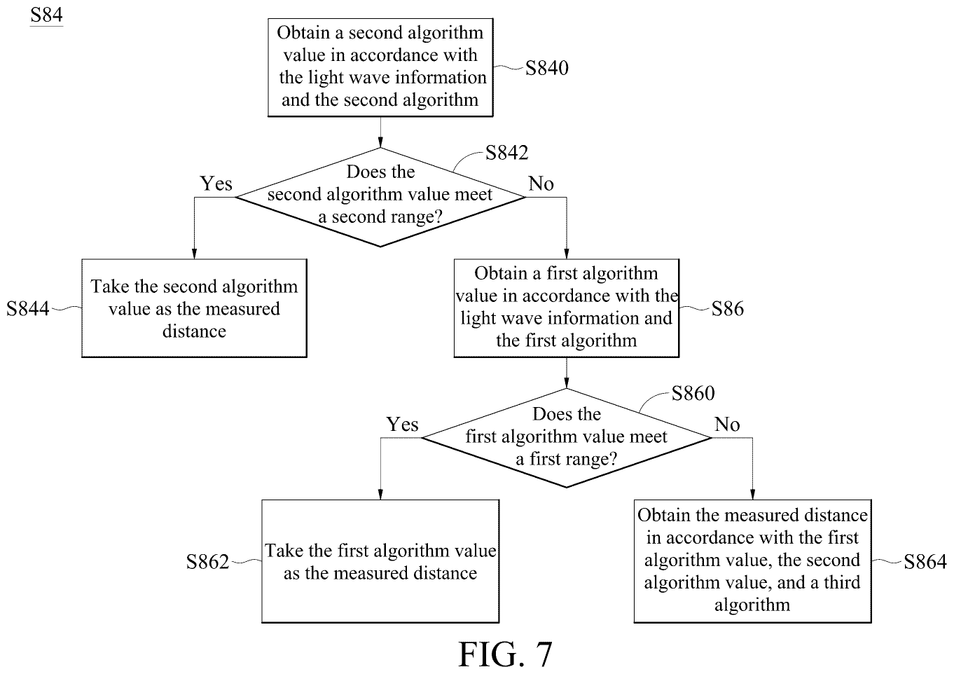

Refer to FIG. 6 and FIG. 7 together. FIG. 6 is a flowchart of a distance sensing method according to some embodiments; and FIG. 7 is a flowchart of step S84 of a distance sensing method according to some embodiments. The operand element 76 may obtain a second algorithm value in accordance with the second algorithm and the light wave information (step S840). When the second algorithm value meets a second range R2 (step S842), the operand element 76 takes the second algorithm value as the measured distance (step S844). The second algorithm may be a direct time of flight (DTOF) algorithm. The second range R2 corresponds to the second distance. In some embodiments, the second range R2 is a range from 80 cm to 125 cm. However, this is not limited thereto. Alternatively, the second range R2 may alternatively be a range from 90 cm to 110 cm, or the second range R2 is a range from an increase of 20% to a decrease of 20% of the second distance L2. Therefore, the sensing element 72 (single photon avalanche diode) stores the received light wave information in the memory element 74. The light wave information is, for example, but not limited to, histogram data. A horizontal axis of a histogram is time, and a vertical axis of the histogram is a quantity of photons. The operand element 76 obtains a second algorithm value in accordance with the histogram data and the second algorithm, where the second algorithm is, for example, but not limited to, the direct time of flight algorithm. The operand element 76 takes the second algorithm value as the measured distance when the second algorithm value falls within the second range R2 (in other words, it indicates that the distance between the to-be-measured object and the distance sensing apparatus 500 is close to the second distance L2). Relationships between upper and lower limits of the second range R2 and the second distance L2 may be obtained through experiments and adjusted in accordance with required precision.

In some embodiments, the first diffraction pattern 56A corresponding to the first distance L1 is the random light spot, and the second diffraction pattern 56B corresponding to the second distance L2 is the regular light spot. The step of “the operand element 76 obtains a second algorithm value in accordance with the light wave information and the second algorithm” is: the operand element 76 calculates a time of flight of photons based on a known time point at which a calibration light spot of the second diffraction pattern 56B (regular light spot) obtains a maximum quantity of photons to obtain a distance between the to-be-measured object and the calibration light spot (single pixel). Then, the operand element 76 obtains the second algorithm value in accordance with distances obtained through a plurality of calibration light spots (so that a three-dimensional image may be established).

Continuing from step S840, in some embodiments, when the second algorithm value does not fall within the second range R2 (step S842), or the operand element 76 cannot obtain the second algorithm value in accordance with the light wave information and the second algorithm (that is, there is an error), the operand element 76 obtains a first algorithm value in accordance with the light wave information and the first algorithm (step S86). The light wave information is, for example, but not limited to, a quantity of full-frame photons. The operand element 76 converts the quantity of full-frame photons into a gray-scale image and obtains the first algorithm value by using a structured light triangulation algorithm. A case in which the operand element 76 cannot obtain the second algorithm value in accordance with the light wave information and the second algorithm (that is, there is an error) may be that the to-be-measured object is too far away or too close to the distance sensing apparatus 500.

In some embodiments, the structured light triangulation algorithm is used in a simple environment (for example, an environment in which there is no interference of another light source and a relative condition between the light source and the to-be-measured object is simple), and the distance sensing apparatus 500 and a to-be-measured plane are parallel to each other. After measuring the distance by the distance sensing apparatus 500, a light spot pattern I_{origin} reflected by the to-be-measured plane in the simple environment and light spot three-dimensional information are obtained and stored. In addition, the distance sensing apparatus 500 measures a to-be-measured object, and the receive module 70 obtains a light spot pattern I_{object}. I_{object} and I_{origin} conform to a two-dimensional transformation relationship, and two-dimensional transformation information may be obtained by comparing I_{object} with I_{origin}. Then, the distance sensing apparatus 500 may calculate third-dimensional transformation of the to-be-measured object, namely, depth information, in accordance with the two-dimensional transformation information, three-dimensional information of I_{origin}, and three-dimensional information of the receive module 70 and the transmit module 50.

When the first algorithm value meets a first range R1 (step S860), the operand element 76 takes the first algorithm value as the measured distance (step S862). For the foregoing embodiment in which the first distance L1 is 60 cm, the first range R1 may be a range from 50 cm to 70 cm or from 45 cm to 75 cm, or a range from an increase of 20% to a decrease of 20% of the first distance L1. Relationships between upper and lower limits of the first range R1 and the first distance L1 may be obtained through experiments and adjusted in accordance with required precision.

In some embodiments, when the second algorithm value does not fall within the second range R2 (step S842), the operand element 76 may increase exposure time and then obtain the first algorithm value in accordance with the light wave information and the first algorithm.

In some embodiments, when the first algorithm value does not meet the first range R1 (step S860), the operand element 76 takes a third algorithm value obtained in accordance with the first algorithm value, the second algorithm value, and the third algorithm as the measured distance (step S864). The third algorithm may be an average calculation, that is, the third algorithm value is an average value of the first algorithm value and the second algorithm value. In some embodiments, the third algorithm is a weighted algorithm. For example, the third algorithm first obtains a first difference between the first algorithm value and the first distance L1 and a second difference between the second algorithm value and the second distance L2 and then obtains the third algorithm value by taking the first difference and the second difference as weights. However, this is not limited thereto. Specifically, a calculation formula of the third algorithm value is as follows:

$$V 3 = V 1 \times ( 1 - \frac{D 1}{D 1 + D 2} ) + V 2 \times ( 1 - \frac{D 2}{D 1 + D 2} ) ,$$

where V1 is the first algorithm value, V2 is the second algorithm value, V3 is the third algorithm value, D1 is the first difference, and D2 is the second difference.

A transfer interval exists between the first distance L1 and the second distance L2, and the light ray images a first transfer pattern (also referred to as a faded first diffraction pattern) and a second transfer pattern (also referred to as a faded second diffraction pattern) at specific positions in the transfer interval. In some embodiments, there is no overlap between the first range R1 and the second range R2. As shown in FIG. 2, an intermediate pattern 56 in FIG. 2 is located in a third range R3, and the intermediate pattern 56 includes a faded first diffraction pattern 56A′ (that is, the first transfer pattern) and a faded second diffraction pattern 56B′ (that is, the second transfer pattern). Taking the first diffraction pattern 56A as an example, the first diffraction pattern 56A is imaged at the first distance L1. After the light ray travels beyond the first distance L1, energy of first light spots 560, 562, and 564 in the first diffraction pattern 56A attenuates as the distance increases. Thus, colors of the received first light spots 560, 562, and 564 are faded, forming faded first light spots 560′, 562′, and 564′ in the faded first diffraction pattern 56A′. The operand element 76 may take a degree of fading of a specific light spot as a threshold for selecting the first algorithm or the second algorithm. Specifically, a first light spot value of the specific first light spots 560, 562, and 564 at the first distance L1 is 255 (where energy corresponding to the value may be obtained through actual measurement, or the value may be directly defined). After the actual measurement, the first light spot value of the specific first light spots 560, 562, and 564 can be set as 127, and the first light spot value may be set as a switching threshold. That is, during the actual measurement, when the obtained first light spot value of the specific first light spots 560, 562, and 564 is less than 127, the second algorithm is used to obtain the measured distance (in other words, the second algorithm value is taken as the measured distance). On the contrary, the measured distance is obtained by using the first algorithm (in other words, the first algorithm value is taken as the measured distance).

Although the foregoing embodiment (one of embodiments of the third algorithm) in which the third algorithm value is obtained by using the faded first light spots 560′, 562′, and 564′ and faded second light spots is applied to the embodiment in which the intermediate pattern 56 is located within the third range R3 (that is, the embodiment in which there is no overlapping region between the first range R1 and the second range R2), the third algorithm is not limited thereto, and the third algorithm may also be applied to an embodiment in which there is an overlapping region between the first range R1 and the second range R2. In addition, the ranges of the first range R1 and the second range R2 may also be adjusted in accordance with precision and requirements of the first algorithm, the second algorithm, and the third algorithm. That is, in the embodiment in which there is an overlapping region between the first range R1 and the second range R2 originally, the third range R3 may also be formed by narrowing the first range R1 and the second range R2, and vice versa.

In the foregoing descriptions, deciding whether to use the first algorithm or the second algorithm is determined in accordance with whether the first algorithm value falls within the first range R1 and whether the second algorithm value falls within the second range R2. However, in some embodiments, a predetermined algorithm may be switched manually, or the operand element 76 monitors a position of a specific light spot and sets a predetermined threshold as a basis for algorithm switching. For setting of the predetermined threshold, refer to FIG. 2. In a process in which the light ray is emitted from an origin O, reaches the center of the third range R3 through the first distance L1, and then reaches the second range R2, when the to-be-measured object is located within the first range R1, the receive module 70 obtains a specific quantity of photons of the first light spots 560, 562, and 564. As the to-be-measured object gradually moves from the origin O into the third range R3, the quantity of photons of the first light spots 560, 562, and 564 obtained by the receive module 70 gradually decreases (in other words, the first light spots gradually become faded), and a quantity of photons of second light spots obtained by the receive module 70 gradually increases (in other words, the second light spots gradually become stronger). Then, when the to-be-measured object gradually moves to the second range R2, the quantity of photons of the first light spots 560, 562, and 564 obtained by the receive module 70 continuously gradually decreases, and the quantity of photons of the second light spots obtained by the receive module 70 continuously gradually increases. When the to-be-measured object is located within the second range R2, the receive module 70 obtains a specific quantity of photons of the second light spots. Therefore, when the quantity of photons of the specific first light spots 560, 562, and 564 is greater than a predetermined threshold, the first algorithm value obtained by using the first algorithm may be taken as the measured distance; and when the quantity of photons of the specific first light spots 560, 562, and 564 is less than the predetermined threshold, the second algorithm value obtained by using the second algorithm is taken as the measured distance. In addition, when a quantity of photons of specific second light spots is greater than a predetermined threshold, the second algorithm value obtained by using the second algorithm may also be taken as the measured distance; and when the quantity of photons of the specific second light spots is less than the predetermined threshold, the first algorithm value obtained by using the first algorithm is taken as the measured distance. When this threshold method is used, a diffraction pattern to which a specific light spot does not belong may be filtered out in advance. For example, if the specific light spot belongs to the first diffraction pattern 56A, the second diffraction pattern 56B is filtered out, and then a quantity of photons of the specific light spot is determined; and if the specific light spot belongs to the second diffraction pattern 56B, the first diffraction pattern 56A is filtered out, and then the quantity of photons of the specific light spot is determined. The foregoing filtering manner is, for example, but not limited to, filtering based on a signal noise ratio (SN ratio).

In addition, when the quantity of photons of the specific first light spots 560, 562, and 564 in the first diffraction pattern 56A is greater than a first threshold, the first algorithm value obtained by using the first algorithm may also be taken as the measured distance; when the quantity of photons of the specific second light spots in the second diffraction pattern 56B is greater than a second threshold, the second algorithm value obtained by using the second algorithm may be taken as the measured distance; and if the quantity of photons of the specific first light spots 560, 562, and 564 is less than the first threshold and the quantity of photons of the specific second light spots is less than the second threshold, the third algorithm value obtained by using the third algorithm may be taken as the measured distance.

In addition, the following formula may also be used to determine whether to calculate the measured distance by using the second algorithm:

$$Z > \frac{2 {D}^{2}}{λ} ,$$

where z is the measured distance, D is a periodic structure spacing of a microstructure, and λ is a wavelength of a light source. If the foregoing formula is met, the operand element 76 takes the second algorithm value obtained by using the second algorithm and the light wave information as the measured distance.

Further, the operand element 76 may simultaneously monitor the quantity of photons of the specific first light spots 560, 562, and 564 of the first diffraction pattern 56A and the quantity of photons of the second light spots of the second diffraction pattern 56B. When a difference between the quantity of photons of the specific first light spots 560, 562, and 564 and the quantity of photons of the specific second light spots is greater than a difference threshold, the operand element 76 takes the first algorithm value obtained by using the first algorithm as the measured distance. Otherwise, the operand element 76 takes the second algorithm value obtained by using the second algorithm as the measured distance.

In some embodiments, the first distance L1 is 40 cm, 80 cm, or 100 cm, and the second distance L2 is 80 cm, 120 cm, or 160 cm. Sizes of the first distance L1 and the second distance L2 are related to the diffractive optical element 52. The first distance L1, the second distance L2, and the diffractive optical element 52 may be designed in accordance with actual application. The scope of the present disclosure is not limited to the foregoing exemplary sizes.

In some embodiments, the transmit module 50 further includes a collimating lens 59. The collimating lens 59 is located between the diffractive optical element 52 and the light-emitting element 54 and is configured to collimate the light ray emitted by the light-emitting element 54 to obtain a collimated beam toward the diffractive optical element 52.

In some embodiments, the receive module 70 further includes a receive end lens 78. The receive end lens 78 is configured to guide the light ray from the to-be-measured object to the sensing element 72.

In some embodiments, the diffractive optical element 52 is a liquid crystal diffractive optical element or a glass diffractive optical element. The liquid crystal diffractive optical element delays and modulates a phase of the passing light ray by using liquid crystal. The glass diffractive optical element includes a substrate made of quartz or glass polymer and a resin layer with a microstructure covering the substrate. The glass diffractive optical element diffracts the passing light ray by using a predefined thickness of the microstructure of the resin layer (where a thickness of each pixel is predefined).

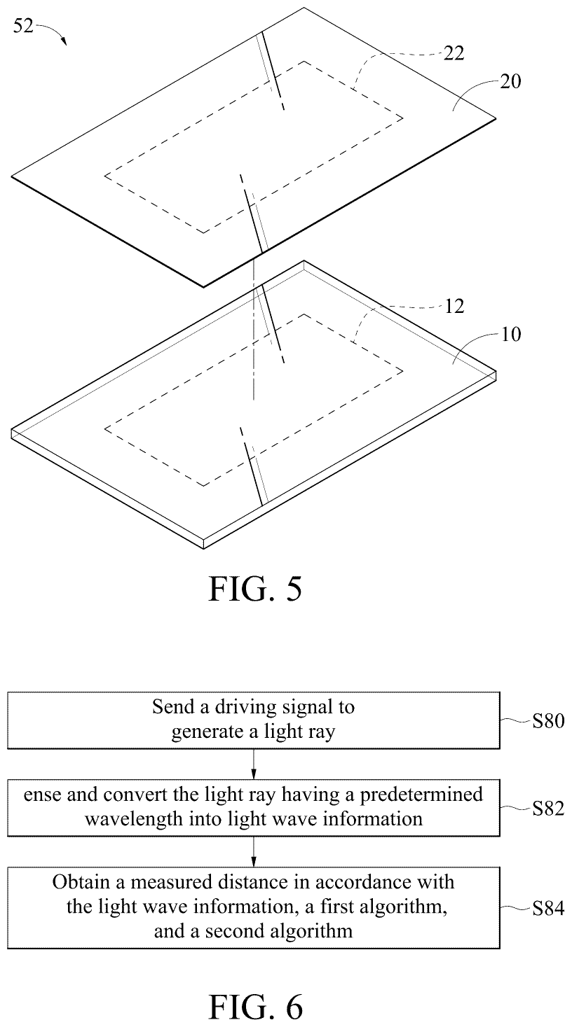

For the foregoing embodiment in which the light ray is diffracted by using the thickness of the microstructure of the resin layer, refer to FIG. 3 to FIG. 5 again. FIG. 4 is a schematic cross-sectional view of FIG. 3 at a position 4-4′, showing a first thickness of a first pixel and a second thickness of a second pixel; and FIG. 5 is a three-dimensional exploded view of a diffractive optical element according to some embodiments. According to some embodiments, the diffractive optical element 52 includes a substrate 10 and a surface layer 20 (for example, the foregoing resin layer). The surface layer 20 covers the substrate 10. The substrate 10 includes a pattern region 12, and the surface layer 20 includes a plurality of sub-patterns 52A and 52B. The surface layer 20 of the diffractive optical element 52 includes the plurality of sub-patterns 52A and 52B. The sub-patterns 52A and 52B respectively include a first sub-pattern 52A and a second sub-pattern 52B. The first sub-pattern 52A is spliced with the second sub-pattern 52B. The first sub-pattern 52A includes a plurality of first pixels A11, A13, A15, A31, and A51, each of the first pixels A11, A13, A15, A31, and A51 has a first thickness, and each first thickness belongs to a plurality of first predetermined values. The second sub-pattern 52B includes a plurality of second pixels B12, B14, B16, B21, and B41, each of the second pixels B12, B14, B16, B21, and B41 has a second thickness, and each second thickness belongs to a plurality of second predetermined values. The first sub-pattern 52A and the second sub-pattern 52B are spliced to form a spliced pattern 22. In some embodiments, the spliced pattern 22 obtained after the first sub-pattern 52A and the second sub-pattern 52B are spliced completely covers the pattern region 12. In some embodiments, the spliced pattern 22 obtained after the first sub-pattern 52A and the second sub-pattern 52B are spliced does not completely cover the pattern region 12.

Referring to FIG. 4, each of the first pixels A11, A13, A15, A31, and A51 has a first thickness, and each of the first thicknesses is one of the first predetermined values. Each of the second pixels B12, B14, B16, B21, and B41 has a second thickness, and each of the second thicknesses is one of the second predetermined values. In some embodiments, a quantity of the first predetermined values is 4, and the four first predetermined values are 470 nm, 940 nm, 1410 nm, and 1880 nm, respectively. In other words, the first thickness of each first pixel is one of 470 nm, 940 nm, 1410 nm, and 1880 nm. A quantity of the second predetermined values is also 4, and the four second predetermined values are 188 nm, 658 nm, 1128 nm, and 1598 nm, respectively. In other words, the second thickness of each second pixel is one of 188 nm, 658 nm, 1128 nm, and 1598 nm. In some embodiments, the quantity of the first predetermined values is different from the quantity of the second predetermined values. In some embodiments, the quantity of the first predetermined values and the quantity of the second predetermined values may each be a multiple of two or are not be a multiple of two. In some embodiments, one of the first predetermined values is the same as one of the second predetermined values (in other words, one of the first thicknesses is the same as one of the second thicknesses).

In some embodiments, as shown in FIG. 5, a surface area of the surface layer 20 (an area of the top view in FIG. 5) is substantially the same as a surface area of the substrate 10 (an area of the top view in FIG. 5), and both the substrate 10 and the surface layer 20 are made of light-transmitting materials. The light-transmitting materials are, for example, but not limited to, glass, acryl, or resin. In some embodiments, the surface area of the surface layer 20 is substantially the same as that of the pattern region 12 of the substrate 10; in other words, the surface layer 20 only covers the pattern region 12.

In some embodiments, the substrate 10 is optical glass, and the surface layer 20 is the resin layer. The resin layer is bonded to the optical glass to form the diffractive optical element 52. In some embodiments, the first pixels A11, A13, A15, A31, and A51 of the first sub-pattern 52A and the second pixels B12, B14, B16, B21, and B41 of the second sub-pattern 52B on the surface layer 20 are microstructures with different thicknesses (the first thicknesses and the second thicknesses) on the resin layer.

In some embodiments, the first sub-pattern 52A has a first distance, and the second sub-pattern 52B has a second distance. When passing through the first sub-pattern 52A, a light ray images at the first distance. When passing through the second sub-pattern 52B, the light ray images at the second distance. The first distance is less than the second distance. Therefore, the first sub-pattern 52A may be referred to as a near-field microstructure sub-pattern, and the second sub-pattern 52B may be referred to as a far-field microstructure sub-pattern. During the design of each of the sub-patterns, an imaging distance is one of the design parameters. Therefore, each of the sub-patterns 52A, 52B, 22A, 22B, 22C (22A, 22B, and 22C will be explained later) has an imaging distance which may be named as a first distance, a second distance, or a third distance (third distance will be explained later). The same can be applied to the first distance and a first microstructure pattern 24A mentioned later, the second distance and a second microstructure pattern 24B mentioned later, and a third distance, a third sub-pattern 22C, and a third microstructure pattern mentioned later.

Still referring to FIG. 6 and FIG. 7, according to some embodiments, a distance sensing method includes the following steps.

Step S80: Sending a driving signal to generate a light ray to cause the light ray to image a first diffraction pattern 56A at a first distance L1 and image a second diffraction pattern 56B at a second distance L2.

Step S82: Sensing and converting the light ray having a predetermined wavelength range into light wave information.

Step S84: Obtaining a measured distance in accordance with the light wave information, a first algorithm, and a second algorithm, where the first algorithm corresponds to the first diffraction pattern 56A, and the second algorithm corresponds to the second diffraction pattern 56B.

Step S84 further includes the following steps.

Step S840: Obtaining a second algorithm value in accordance with the light wave information and the second algorithm.

Step S842: Determining whether the second algorithm value meets a second range R2.

Step S844: Taking the second algorithm value as the measured distance in response to the second algorithm value meeting a second range R2.

Step S86: Obtaining a first algorithm value in accordance with the light wave information and the first algorithm in response to the second algorithm value not meeting the second range R2.

Step S860: Determining whether the first algorithm value meets a first range R1.

Step S862: Taking the first algorithm value as the measured distance in response to the first algorithm value meeting the first range R1.

Step S864: Taking a second algorithm value obtained in accordance with the first algorithm value, the second algorithm value, and a third algorithm as the measured distance in response to the first algorithm value not meeting the first range R1.

Details of the steps of the distance sensing method are described in detail above. Therefore, details are not described herein again.

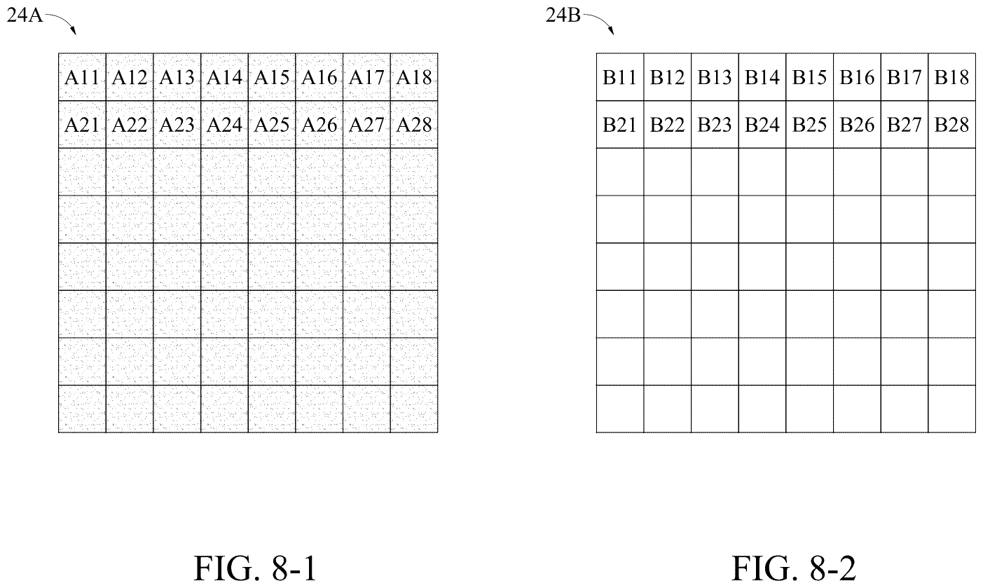

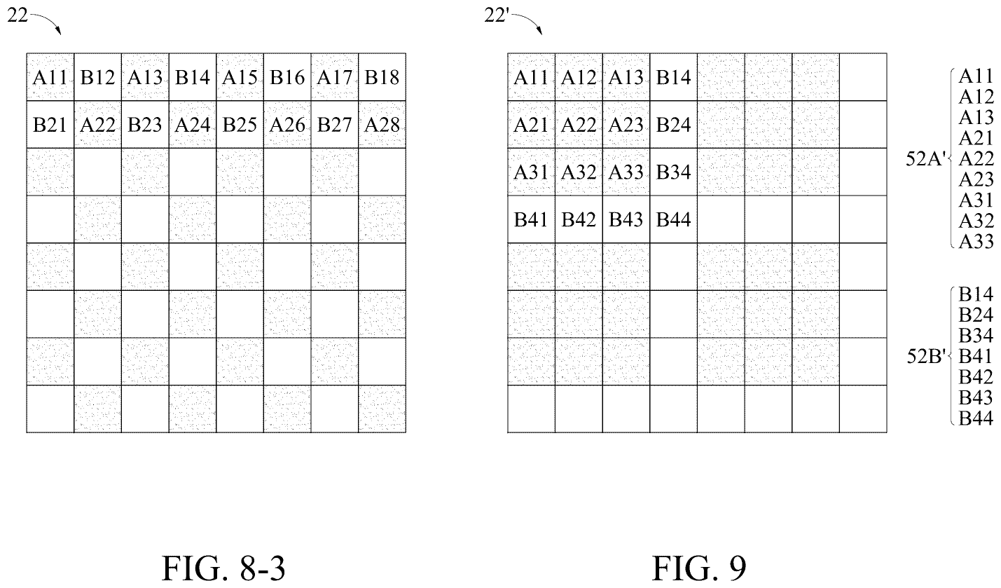

FIG. 8-1, FIG. 8-2, and FIG. 8-3 are schematic diagrams of a first microstructure pattern, a second microstructure pattern, a first sub-pattern, a second sub-pattern, and a spliced pattern according to some embodiments. FIG. 8-1, FIG. 8-2, and FIG. 8-3 respectively show patterns with only 64 pixels as examples. FIG. 8-1 shows that a first microstructure pattern 24A includes 64 first pixels (only first pixels A11 to A18 in a first row and first pixels A21 to A28 in a second row are marked in the drawing). FIG. 8-2 shows that a second microstructure pattern 24B includes 64 second pixels (only second pixels B11 to B18 in a first row and second pixels B21 to B28 in a second row are marked in the drawing). A first sub-pattern 52A is a part of the first microstructure pattern 24A, and a second sub-pattern 52B is a part of the second microstructure pattern 24B. The “part” referred to herein means that the first sub-pattern 52A has a part of the first pixels of the first microstructure pattern 24A from a pixel perspective; in other words, features of first pixels of the first sub-pattern 52A are the same as features of corresponding first pixels of the first microstructure pattern 24A, for example, a position (coordinates) and a thickness; and the second sub-pattern 52B has a part of the second pixels of the second microstructure pattern 24B; in other words, features of second pixels of the second sub-pattern 52B are the same as features of corresponding second pixels of the second microstructure pattern 24B. In the embodiment of FIG. 8-3, a quantity of the first pixels of the first sub-pattern 52A is half that of a quantity of the first pixels of the first microstructure pattern 24A, and positions (coordinates) and thicknesses of the first pixels of the first sub-pattern 52A are the same as positions (coordinates) and thicknesses of the corresponding first pixels of the first microstructure pattern 24A; and a quantity of the second pixels of the second sub-pattern 52B is half a quantity of the second pixels of the second microstructure pattern 24B, and positions (coordinates) and thicknesses of the second pixels of the second sub-pattern 52B are the same as positions (coordinates) and thicknesses of the corresponding second pixels of the second microstructure pattern 24B. The coordinates (positions) of the first pixels of the first sub-pattern 52A do not overlap with the coordinates (positions) of the second pixels of the second sub-pattern 52B (they are staggered in a checkerboard-like manner). Therefore, the spliced pattern 22 includes 32 first pixels and 32 second pixels.

The first microstructure pattern 24A has the first distance, and the second microstructure pattern 24B has the second distance. When passing through the first microstructure pattern 24A, a light ray images a pattern at the first distance. When passing through the second microstructure pattern 24B, the light ray images a pattern at the second distance. As described above, the first distance is less than the second distance, the first microstructure pattern 24A is referred to as a near-field microstructure pattern, and the second microstructure pattern 24B is referred to as a far-field microstructure pattern. In some embodiments, the quantity of the first pixels of the first microstructure pattern 24A is the same as the quantity of second pixels of the second microstructure pattern 24B and a sum of the two quantities is the same as a quantity of pixels of the spliced pattern 22. However, the quantity of the first pixels of the first microstructure pattern 24A may also be different from the quantity of second pixels of the second microstructure pattern 24B. In the spliced pattern 22 in this embodiment, a splicing ratio (a pixel quantity ratio) of the first sub-pattern 52A to the second sub-pattern 52B is 1:1.

Refer to FIG. 9. FIG. 9 is a schematic diagram of a spliced pattern according to some embodiments. FIG. 9 shows a pattern with only 64 pixels as an example. In the embodiments, a first sub-pattern 52A′ of a spliced pattern 22′ includes 36 first pixels (for example, pixels whose first characters are A in the drawing), and a second sub-pattern 52B′ of the spliced pattern 22′ includes 28 second pixels (for example, pixels whose first characters are B in the drawing). In the spliced pattern 22′ in the embodiments, a splicing ratio (a pixel quantity ratio) of the first sub-pattern 52A′ to the second sub-pattern 52B′ is 9:7.

It can be learned from FIG. 8-3 and FIG. 9 that, a splicing manner of forming a spliced pattern by splicing a plurality of sub-patterns may be adjusted in accordance with a requirement or an imaging result and is not limited to the splicing manners shown in FIG. 8-3 and FIG. 9.

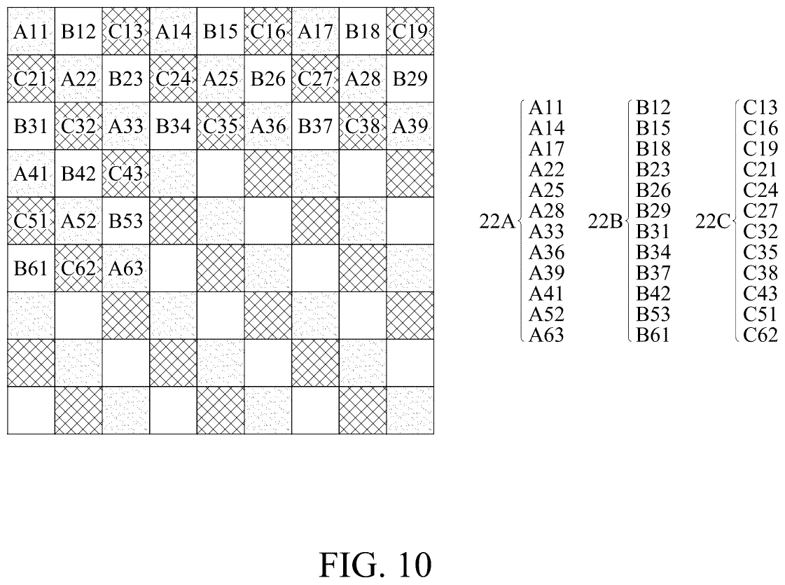

In each of the embodiments of FIG. 8-3 and FIG. 9, a total quantity of pixels of the spliced pattern 22 or 22′ is the same as a total quantity of pixels of the first microstructure pattern 24A and a total quantity of pixels of the second microstructure pattern 24B. In some embodiments, a quantity of first pixels of the first sub-pattern 52A or 52A′ plus a quantity of second pixels of the second sub-pattern 52B or 52B′ of the spliced pattern 22 or 22′ is less than the total quantity of pixels of the first microstructure pattern 24A or less than the total quantity of pixels of the second microstructure pattern 24B. For example, the quantity of first pixels of the first sub-pattern 52A or 52A′ is one-third of the total quantity of pixels of the first microstructure pattern 24A, and the quantity of second pixels of the second sub-pattern 52B or 52B′ is one-third of the total quantity of pixels of the second microstructure pattern 24B. Therefore, although the total quantity of pixels of the spliced pattern 22 or 22′ is the same as the sum of the total quantity of pixels of the first microstructure pattern 24A and the total quantity of pixels of the second microstructure pattern 24B, only two thirds of pixels of the spliced pattern 22 or 22′ have microstructures (respectively corresponding to the first microstructure pattern 24A and the second microstructure pattern 24B). The splicing manner may be similar to, but not limited to, the splicing manner shown in FIG. 10 (in this example, thicknesses of pixels numbered C13, C16, C19, C21, C24, C27, C32, C35, C38, C43, C51, and C62 in FIG. 10 do not correspond to a microstructure pattern, or when passing through the pixels, a light ray does not image a predetermined pattern at a predetermined distance).

Still referring to FIG. 2, in some embodiments, the first microstructure pattern 24A and the second microstructure pattern 24B are manufactured in the following manner. First, a far-field target pattern (that is, the second diffraction pattern 56B) is designed. In accordance with a known light source condition, the target pattern is designed as a regular matrix of light spots (as shown in FIG. 2). Then, a near-field target pattern (that is, the first diffraction pattern 56A) is designed as a target pattern with random points. During the design of the near-field target pattern, the far-field target pattern 56B is first copied, and the far-field target pattern 56B is rotated by a predetermined angle, for example, but not limited to, 8°; and then, the rotated far-field target pattern 56B is overlapped with the original far-field target pattern to obtain the near-field target pattern with the random points. Then, the near-field target pattern 56A, the first distance L1 (for example, 60 cm), and other known conditions are substituted into an Iterative Fourier Transform Algorithm to generate a near-field phase distribution pattern. In addition, the far-field target pattern 56B, the second distance L2 (for example, 100 cm), and other known conditions are substituted into the Iterative Fourier Transform Algorithm to generate a far-field phase distribution pattern. Then, the near-field phase distribution pattern and the far-field phase distribution pattern are respectively substituted into an optimization algorithm to obtain a near-field microstructure pattern (that is, the first microstructure pattern 24A) and a far-field microstructure pattern (that is, the second microstructure pattern 24B). In this way, a conversion relationship exists between each of first pixels A11, A13, A15, A31, and A51 and each of second pixels B12, B14, B16, B21, and B41. The foregoing other known conditions are, for example, but not limited to, optical parameters of a light source and a diffractive element such as a light source wavelength, a light source position, and a microstructure pixel size. The foregoing manufacturing manner is merely an example, and the present disclosure is not limited thereto.

Refer to FIG. 10. FIG. 10 is a partially enlarged schematic view of a spliced pattern according to some embodiments, where the spliced pattern is formed by splicing a first sub-pattern, a second sub-pattern, and a third sub-pattern. FIG. 10 shows a pattern with only 81 pixels as an example, and only numbers of a part of the pixels according to positions (coordinates) of the pixels are marked in the drawing. It can be seen from the drawing that, in the embodiments, a surface layer 20 of a diffractive optical element 52 includes a first sub-pattern 22A, a second sub-pattern 22B, and a third sub-pattern 22C. The first sub-pattern 22A, the second sub-pattern 22B, and the third sub-pattern 22C are spliced and cover a pattern region (not shown in the drawing, refer to FIG. 2) of a substrate 10 of the diffractive optical element 52. The first sub-pattern 22A includes a plurality of first pixels A11, A14, A17, A22, A25, A28, A33, A36, A39, A41, A52, and A63. The second sub-pattern 22B includes a plurality of second pixels B12, B15, B18, B23, B26, B29, B31, B34, B37, B42, B53, and B61. The third sub-pattern 22C includes a plurality of third pixels C13, C16, C19, C21, C24, C27, C32, C35, C38, C43, C51, and C62. Each of the first pixels All, A14, A17, A22, A25, A28, A33, A36, A39, A41, A52, and A63 has a first thickness, and each first thickness belongs to a plurality of first predetermined values. Each of the second pixels B12, B15, B18, B23, B26, B29, B31, B34, B37, B42, B53, and B61 has a second thickness, and each second thickness belongs to a plurality of second predetermined values. Each of the third pixels C13, C16, C19, C21, C24, C27, C32, C35, C38, C43, C51, and C62 has a third thickness, and each third thickness belongs to a plurality of third predetermined values. The first thicknesses, the second thicknesses, the third thicknesses, the first predetermined value, the second predetermined value, and the third predetermined value are similar to those in the foregoing embodiments, and details are not described again.

In this embodiment, the first sub-pattern 22A is a part of a first microstructure pattern (not shown, similar to that of FIG. 8-1), the second sub-pattern 22B is a part of a second microstructure pattern (not shown, similar to that of FIG. 8-2), and the third sub-pattern is a part of a third microstructure pattern (not shown, similar to that of FIG. 8-1, where A is replaced with C; or similar to that of FIG. 8-2, where B is replaced with C). The first sub-pattern 22A and the first microstructure pattern have a first distance, the second sub-pattern 22B and the second microstructure pattern have a second distance, and the third sub-pattern 22C and the third microstructure pattern have a third distance. When passing through the first sub-pattern 22A, a light ray images a first diffraction pattern (not shown) at the first distance. When passing through the second sub-pattern 22B, the light ray images a second diffraction pattern (not shown) at the second distance. When passing through the third sub-pattern 22C, the light ray images a third diffraction pattern (not shown) at the third distance. The drawings do not show the first diffraction pattern, the second diffraction pattern, and the third diffraction pattern of the embodiments. The reason is that, as described above, the first diffraction pattern, the second diffraction pattern, and the third diffraction pattern are light spots corresponding to target patterns pre-designed in accordance with a light source condition, and are similar to 56A or 56B in FIG. 2. Therefore, the light spots of the diffraction patterns correspond to the target patterns.

Further, the splicing manner of the first sub-pattern 22A, the second sub-pattern 22B, and the third sub-pattern 22C is not limited to the splicing manner in the embodiment of FIG. 10, and other splicing manners may be used during implementation, as long as the first, second, and third diffraction patterns can respectively result in imaging at the first, second, and third distances after a light ray passes through.

In some embodiments, a plurality of sub-patterns on the surface layer 20 of the diffractive optical element 52 include a first sub-pattern, a second sub-pattern, a third sub-pattern, and a fourth sub-pattern (not shown in the drawings). A spliced pattern is formed by splicing the first sub-pattern, the second sub-pattern, the third sub-pattern, and the fourth sub-pattern. Feature details are similar to those described above, and details are not described again. Therefore, when a light ray passes through the diffractive optical element 52 having the four sub-patterns, the light ray images a first diffraction pattern, a second diffraction pattern, a third diffraction pattern, and a fourth diffraction pattern at a first distance, a second distance, a third distance, and a fourth distance, respectively.

For the diffractive optical element 52 used in the distance sensing apparatus 500 and method, the first diffraction pattern 56A can be imaged at the first distance L1, and the second diffraction pattern 56B can be imaged at the second distance L2. However, the scope of the present disclosure is not limited thereto. For the diffractive optical element 52 used during implementation, corresponding diffraction patterns may alternatively be imaged at three or more distances, and the measured distance may be obtained in accordance with the foregoing method by using algorithms corresponding to the diffraction patterns and the light wave information.

In summary, according to the distance sensing apparatus and method in some embodiments, a measured distance can be obtained more accurately through imaging of corresponding diffraction patterns at a plurality of distances respectively and calculation using algorithms corresponding to the diffraction patterns.

Although the present disclosure has disclosed the foregoing embodiments, the embodiments are not intended to limit the present disclosure. Any person of ordinary skill in the art may make modifications and changes without departing from the spirit and scope of the contents of the present disclosure. The modifications and changes should be subject to the patent scope of the present disclosure.

What is claimed is:

1. A distance sensing apparatus comprising:
a transmit module comprising:
a diffractive optical element comprising a first sub-pattern and a second sub-pattern;
a light-emitting element configured to be driven to output a light ray toward the diffractive optical element, wherein the light ray has a predetermined wavelength range, and in response to passing through the diffractive optical element, the light ray forms a first diffraction pattern at a first distance and a second diffraction pattern at a second distance, respectively; and
a driving element configured to receive a driving signal and drive the light-emitting element; and
a receive module comprising:
a sensing element configured to sense and convert the light ray having the predetermined wavelength range into light wave information;
a memory element configured to store the light wave information; and
an operand element configured to send the driving signal and obtain a measured distance in accordance with the light wave information, a first algorithm, and a second algorithm, wherein the first algorithm corresponds to the first diffraction pattern, and the second algorithm corresponds to the second diffraction pattern.

2. The distance sensing apparatus according to claim 1, wherein the operand element is configured to obtain a second algorithm value in accordance with the light wave information and the second algorithm; and the operand element is configured to take the second algorithm value as the measured distance in response to the second algorithm value meeting a second range.

3. The distance sensing apparatus according to claim 2, wherein the operand element is configured to obtain a first algorithm value in accordance with the light wave information and the first algorithm in response to the second algorithm value not meeting the second range; and the operand element is configured to take the first algorithm value as the measured distance in response to the first algorithm value meeting a first range.

4. The distance sensing apparatus according to claim 3, wherein the operand element is configured to obtain the measured distance in accordance with the first algorithm value and the second algorithm value in response to the first algorithm value not meeting the first range.

5. The distance sensing apparatus according to claim 4, wherein the measured distance is an average of the first algorithm value and the second algorithm value.

6. The distance sensing apparatus according to claim 1, wherein the first sub-pattern comprises a plurality of first pixels, the second sub-pattern comprises a plurality of second pixels, and a conversion relationship exists between each of the first pixels and each of the second pixels.

7. The distance sensing apparatus according to claim 4, wherein a transfer interval exists between the first distance and the second distance, and the light ray images a first transfer pattern and a second transfer pattern at specific positions in the transfer interval.

8. The distance sensing apparatus according to claim 1, wherein the light wave information comprises a plurality of characteristic photons.

9. A distance sensing method, comprising:
sending a driving signal to generate a light ray to cause the light ray to image a first diffraction pattern at a first distance and image a second diffraction pattern at a second distance;
sensing and converting the light ray having a predetermined wavelength range into light wave information; and
obtaining a measured distance in accordance with the light wave information, a first algorithm, and a second algorithm, wherein the first algorithm corresponds to the first diffraction pattern, and the second algorithm corresponds to the second diffraction pattern.

10. The distance sensing method according to claim 9, wherein the step of obtaining a measured distance in accordance with the light wave information, a first algorithm, and a second algorithm comprises:
obtaining a second algorithm value in accordance with the light wave information and the second algorithm; and
taking the second algorithm value as the measured distance in response to the second algorithm value meeting a second range.

11. The distance sensing method according to claim 10, further comprising:
obtaining a first algorithm value in accordance with the light wave information and the first algorithm in response to the second algorithm value not meeting the second range; and
taking the first algorithm value as the measured distance in response to the first algorithm 10 value meeting a first range.

12. The distance sensing method according to claim 11, further comprising: obtaining the measured distance in accordance with the first algorithm value, the second algorithm value, and a third algorithm in response to the first algorithm value not meeting the first range.
